(19) United States
(12) Patent Application Publication
(10) Pub. No.: US 2012/0293310 A1
(43) Pub. Date: Nov. 22, 2012

(54) Method and Apparatus Pertaining to Using a Door Chime to Audibilize Non-Door-Chime Messages

(75) Inventors: James J. Fitzgibbon, Batavia, IL (US); Mark L. Karasek, Lombard, IL (US); William F. Ott, Gallatin, TN (US)

(73) Assignee: HEATHCO, LLC, Bowling Green, KY (US)

(21) Appl. No.: 13/109,469

(22) Filed: May 17, 2011

(51) Int. Cl. G08B 3/00

(52) U.S. Cl. 340/328

(57) ABSTRACT

A door-chime apparatus comprises a door-chime chassis that will permit the apparatus to be installed in a building (such as residence). This door-chime chassis supports other elements including a door-chime user-input interface and a wireless interface, both of which operably couple to a control circuit. The control circuit, in turn, audibilizes a door chime within the building when a user asserts a user input (such as a typical door-bell button) that couples to the door-chime user-input interface. In addition, this control circuit, upon reception of a recognized non-door-chime message via the wireless interface, will cause the audibilization of a message other than a door chime within the building. These teachings will accommodate sourcing the aforementioned non-door-chime message from any of a variety of apparatuses. Examples in these regards include residential utilities, residential appliances, and residential sensors. By one approach the audibilized message can comprise audibilized words.

### TECHNICAL FIELD

This invention relates generally to door chimes.

### BACKGROUND

There are numerous apparatuses in modern buildings (such as a residence) that are characterized by an operating cycle. For example, laundry washers and dryers, microwave ovens, garage door openers, and automatic dishwashers all typically conclude their operations upon achieving some milestone event (sometimes based on time and sometimes based upon one or more monitored conditions). That the operation concludes can be of interest to, for example, persons in the building such as, for example, the homeowner. Notwithstanding this potential interest, many apparatuses offer no particular signal when their operating cycle concludes.

In other cases, the apparatus does provide a signal. For example, a laundry dryer may ring a bell or audibilize a musical melody upon concluding its operating cycle. In many application settings, however, the proffered signal may not reach the homeowner's hearing. This can happen, for example, when the homeowner is sufficiently distant from the apparatus. This can also happen when other noise sources (such as a television) that are proximal to the homeowner effectively mask such signals.

his lack of communicative wherewithal negatively impacts other circumstances as well. For example, some apparatuses have self-diagnostic functionality and are capable of providing a signal when a fault or failure condition regarding the apparatus occurs. In other cases, the apparatus itself comprises a sensor tasked with providing a signal when a sensed event occurs. In at least some application settings, however, these signals may again go unheard by the intended audience for an unacceptable period of time.

### BRIEF DESCRIPTION OF THE DRAWINGS

The above needs are at least partially met through provision of the method and apparatus pertaining to using a door chime to audibilize non-door-chime messages described in the following detailed description, particularly when studied in conjunction with the drawings, wherein:

FIG. 1 comprises a block diagram as configured in accordance with various embodiments of the invention;

FIG. 2 comprises a block diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a block diagram as configured in accordance with various embodiments of the invention; and

FIG. 6 comprises a front-elevational cutaway schematic diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a door-chime apparatus comprises a door-chime chassis that will permit the apparatus to be installed in a building (such as residence). This door-chime chassis supports other elements including a door-chime user-input interface and a wireless interface, both of which operably couple to a control circuit. The control circuit, in turn, audibilizes a door chime within the building when a user asserts a user input that couples to the door-chime user-input interface. In addition, this control circuit, upon reception of a recognized non-door-chime message via the wireless interface, will cause the audibilization of a message other than a door chime within the building.

These teachings will accommodate sourcing the aforementioned non-door-chime message from any of a variety of non-door-chime apparatuses. Examples in these regards include residential utilities, residential appliances, and residential sensors.

By one approach the audibilized message can comprise audibilized words. These words, in turn, can be substantively and contextually explanatory or instructive with respect to the source of the message and/or the circumstances instigating the sending of the message. For example, the audibilized message can specifically identify a particular non-door-chime apparatus along with an operating state, fault condition, condition warning, or the like.

If desired, the apparatus that sources the recognized non-door-chime message can include with that message the audibilizable words themselves. In other cases, part or all of the audibilizable words can be stored and accessed local to the door-chime apparatus itself.

These teachings will also optionally accommodate permitting the door-chime apparatus, either automatically or in response to a specific user command, to poll one or more non-door-chime apparatuses regarding their present state. The door-chime apparatus can then audibilize a message to express the status-condition response.

By one approach these aforementioned recognized non-door-chime messages can include authentication content to permit the door-chime apparatus to respond as described to only authorized message sources. This authentication content can vary with the needs and/or opportunities as tend to characterize a given application setting. Examples include, but are not limited to, fixed codes, rolling codes, and so forth.

So configured, a door-chime apparatus can serve as an effective (in fact, literal) voice for any number of other utilities, appliances, and/or sensors. As door-chime apparatuses are typically centrally located in the average residence, and are essentially designed and installed to tend to ensure that the door chime itself is readily heard throughout the residence, the applicant has determined that a door-chime apparatus is more likely, under many operating circumstances, to be heard effectively throughout the residence than most other non-door-chime apparatuses. As a result, a homeowner can more reliably be informed when various apparatuses complete their operating cycles, detect a troubling condition, or the like.

These teachings can be economically implemented. These teachings are also highly flexible in practice and will accommodate a great number of differing operating needs. Furthermore, these teachings are highly scalable in practice and can be employed with a virtually unlimited number of non-door-chime apparatuses.

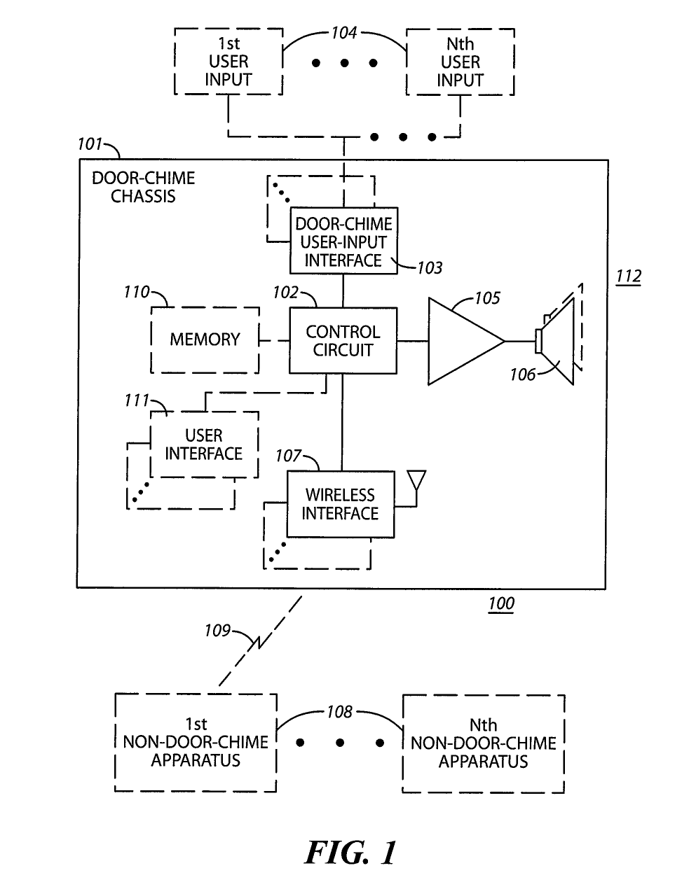

These and other benefits may become clearer upon making a thorough review and study of the following detailed description. Referring now to the drawings, and in particular to FIG. 1, an illustrative door-chime apparatus 100 suitable for use in conjunction with these teachings will first be described. It will be understood that no particular limitations are intended via presentation and discussion of the specifics of these various examples. Instead, these described examples are intended to serve a generally illustrative purpose.

This door-chime apparatus 100 includes a door-chime chassis 101. This chassis 101 is configured to facilitate installing the door-chime apparatus 100 in a building. The particular manner of installation can vary and there are, indeed, numerous existing practices in these regards that anticipate both permanent and temporary installations. This can include the use, for example, of holes through the door-chime chassis 101 through which attachment members (such as nails, brads, screws, hooks, or bolts) can be disposed in order to engage, for example, a wall or ceiling of the building. Other examples include tapered, spike-like members that extend outwardly of the door-chime chassis 101 and that are designed and intended to be driven into frictional engagement with a wall or ceiling of the building. As yet another example the door-chime chassis 101 can include one or more engagement members or mechanisms to permit attaching the door-chime chassis 101 to another member (such as an appropriately configured plate) that is itself attached to the building.

These teachings will also accommodate configuring the door-chime chassis 101 as a plug-in unit that becomes installed by physically and electrically connecting the door-chime chassis 101 into a corresponding receiving component (which may, or may not, itself comprise a chassis). The electrical connection can be facilitated in any of a variety of ways that are known in the art. A non-exhaustive listing in these regards includes electrical sockets and (captivating or non-captivating) connectors of various kinds, terminal-based electrical connections, and so forth.

These teachings, in fact, will accommodate a wide variety of already-known practices in these regards. As the present teachings are not especially sensitive to any particular choices in these regards, for the sake of brevity further elaboration along these lines will not be provided here.

In many application settings the door-chime apparatus 100 will also include a housing (not shown). This housing may integrally include the aforementioned door-chime chassis 101 or not as desired. Again, the present teachings are not particularly sensitive to any choices that the designer might make as to whether to include a housing, or what type of housing to utilize in a given application setting.

This door-chime chassis 101, in turn, serves to support (directly or indirectly) a number of other components including a control circuit 102. Such a control circuit 102 can comprise a fixed-purpose hard-wired platform or can comprise a partially or wholly programmable platform. All of these architectural options are well known and understood in the art and require no further description here. This control circuit 102 can be configured (for example, via corresponding programming when the control circuit 102 comprises a partially or wholly programmable platform) to carry out one or more of the steps, actions, or functions described herein as desired.

The door-chime chassis 101 also supports a door-chime user-input interface 103. This door-chime user-input interface 103 operably couples to the control circuit 102 and can comprise, as desired, a wireless interface and/or a non-wireless interface of choice. This door-chime user-input interface 103, in turn, serves to receive inputs from one or more user inputs 104 (via a corresponding wireless or non-wireless connection as appropriate to the application setting). In many applications, and by way of example, these user inputs 104 can comprise doorbell buttons as are known in the art. The interested reader can find more details regarding wireless and non-wireless door-chime interfaces as well as alternatives regarding how to power such a system by referring to a patent application entitled Method and Apparatus Pertaining to Doorbell Chimes as filed on Mar. 31, 2009 (U.S. patent application Ser. No. 12/415,398), the full and entire contents of which are fully incorporated herein by this reference.

Such user input will hence comprise a door-chime message to which the control circuit 102 can respond by audibilizing a door chime within the building 112. There are numerous approaches known to audibilize a door chime including both mechanical mechanisms (such as striking a tubular bell) and electrical approaches (offering everything from simple chirp noises to complex musical pieces produced by electronic circuits). For the sake of illustration and without intending any limitations in these regards, FIG. 1 depicts the door-chime apparatus 100 as including an audio amplifier 105 and a corresponding speaker(s) 106 (with these components also being supported by the door-chime chassis 101). These components operably couple to the control circuit 102. The latter, in turn, outputs a door-chime audio signal that the audio amplifier 105 amplifies and renders audible via the speaker(s) 106.

The door-chime apparatus 100 may have only a single sound to use as a door chime. These teachings will also accommodate, however, providing a plurality of available door-chime sounds. This will permit, for example, using a first door-chime sound when responding to user inputs from a doorbell button at the front door of a residence and using a second, different door-chime sound when responding to user inputs from a doorbell button at a different door to the residence. This will also permit, for example, permitting the homeowner to vary the door chime sound that the door-chime apparatus 100 renders audible when responding to a given user input 104 to suit their preferences.

This door-chime apparatus 100 also comprises, in this illustrative example, one or more wireless interfaces 107. This wireless interface(s) 107 is supported in this example by the door-chime chassis 101 and operably couples to the control circuit 102 as well. So configured, this wireless interface(s) 107 can wirelessly communicate with one or more non-door-chime apparatuses 108. These non-door-chime apparatuses 108 are described in more detail further below. For the moment it may simply be noted that these non-door-chime apparatuses 108 are configured to source and transmit a non-door-chime message 109 that the control circuit 102 will receive (via the wireless interface(s) 107) and recognize. These messages 109, in turn, cause the control circuit 102 to audibilize a message other than a door chime within the building 112.

In the examples provided above, the door-chime user-input interface 103 and the wireless interface 107 are shown as discrete components. If desired, however, these teachings will optionally accommodate integrating the respective functionality of these two interfaces 103 and 107 into a shared platform. For example, the wireless interface 107 can be configured to compatibly receive wireless transmissions from one or more user inputs 104 as are otherwise described above.

Accordingly, the illustrated door-chime apparatus 100 as configured will audibilize messages that are unrelated to sounding a door chime per se under certain operating conditions. In some cases, to help ensure that those hearing the door-chime apparatus 100 perceive and understand the difference, the door-chime apparatus 100 may be configured to avoid using the same signals for non-door-chime-related messages that are available for use as a door chime.

In some cases it can be useful for the door-chime apparatus 100 to include a memory 110 that operably couples to the control circuit 102. When the control circuit 102 comprises a partially or wholly programmable platform, for example, this memory 110 can store the executable code that, when executed by the control circuit 102, causes the control circuit 102 to carry out desired steps, actions, or functions. This memory 110 can also serve (in lieu of the foregoing or in combination therewith) to store other information including, for example, local audio source content (including either or both of door chime content and non-door-chime message content).

These teachings will also accommodate including one or more user interfaces 111. This can include essentially any input mechanism (including buttons, switches, touch-sensitive panels, voice recognition modules, cursor-control mechanisms, keys, keypads and keyboards, and so forth) and/or any output mechanism (including any of a wide variety of displays and audio transducers). Such a user interface 111 can serve, for example, to permit a user to assign a particular available door chime sound to a particular user input 104 or to assign a particular message to a particular non-door-chime message 109 or non-door-chime apparatus 108. The present teachings contemplate other optional uses for such a user interface 111 as well and specific examples will be provided further herein.

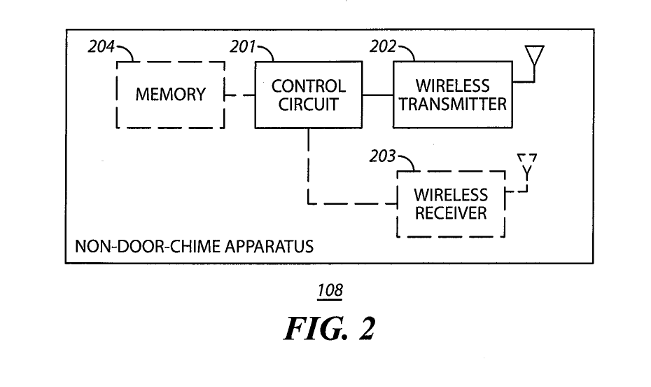

Referring now to FIG. 2, an illustrative example of a non-door-chime apparatus 108 will be described. These teachings will accommodate a wide variety of possibilities in these regards. Generally speaking, by one approach the non-door-chime apparatus 108 can comprise any of a variety of residentially-intended/fielded apparatuses. Corresponding examples include, but are not limited to, residential utilities, residential appliances, and residential sensors, to note but a few.

Residential utilities are apparatuses that, once installed, comprise a part of the residence's infrastructure (often hidden from view, such as behind walls or doors or in garages or basements) and typically lack much in the way of a visual design aesthetic; these components serve a utilitarian function and their appearance supports that role. Examples in these regards include, but are not limited to, installed pumps (such as a water pump in a well, a sump pump, or a sewage pump, to note but a few examples in these regards), a central furnace (including heat pumps), a central air conditioner, a central humidity controller, a movable barrier operator (such as a garage door opener, a driveway gate opener, and so forth), a water softener, a garbage disposal, or an installed electricity generator (such as a gas or natural gas generator, a wind-powered generator, a solar-powered electricity source, and so forth).

Residential appliances may, or may not, be installed as well but otherwise tend to offer a design aesthetic that goes beyond mere utility. Examples include installed kitchen appliances (other than a garbage disposal which tends towards a utilitarian look and is usually installed out of sight) and laundry appliances. More specific examples include, but are not limited to, clothes washers, clothes dryers, stoves, ovens, indoor grills, installed exhaust fans, automatic dishwashers, refrigerators, freezers, microwave ovens, trash compactors, and so forth.

Residential sensors, in turn, are apparatuses that serve, as a primary or sole function, to detect one or more predetermined conditions. Examples include, but are not limited to, smoke detectors, gas detectors, movement detectors (including, by way of example, passive-infrared-based detectors regardless whether they are standalone components or comprise an integral part of some other apparatus such as a light fixture), a living-presence detector (such as a human detector or animal detector), a water detector (to detect, for example, flooded conditions in a basement), an environmental-state detector (to detect, for example, internal or external temperature or humidity, frost conditions, rain or other precipitation, wind, and so forth), an access detector (such as, but not limited to, a door-state detector (to detect, for example, whether a door is open, closed, opening, closing, or somewhere in between)), a weight-based detector (to determine, for example, whether a visitor is standing outside the residence at the front door), or a window-state detector with other possibilities existing.

The non-door-chime apparatus 108 includes a control circuit 201 and a wireless transmitter 202 that operably couples to the control circuit 201. As with the door-chime apparatus 100, the control circuit 201 can comprise a fixed-purpose component or can comprise a partially or wholly programmable platform. By one approach the control circuit 201 is configured (for example, by appropriate programming) to cause the wireless transmitter 202 to transmit the aforementioned message to the door-chime apparatus 100 to thereby cause the latter to audibilize a non-door-chime message. This wireless transmitter 202 can utilize one or more carrier frequencies of choice and any modulation of choice, though compatible operation with the wireless interface 107 of the door-chime apparatus 100 will be preferred in many application settings.

By one approach this non-door-chime apparatus 108 can also optionally include a wireless receiver 203 that also operably couples to the control circuit 201. So configured, and as described below, the non-door-chime apparatus 108 can receive a signal from the door-chime apparatus 100 to which the non-door-chime apparatus 108 can respond by providing a status-update message regarding the non-door-chime apparatus 108.

Also if desired, this non-door-chime apparatus 108 can optionally include a memory 204 that operably couples to the control circuit 201. This memory 204 can store, for example, executable software instructions to be used by the control circuit 201 when the latter comprises a partially or wholly programmable platform. This memory 204 can also store, if desired, one or more messages, including status messages, that the non-door-chime apparatus 108 can transmit to the door-chime apparatus 100 per these teachings.

So configured, a non-door-chime apparatus 108 can operate compatibly with the aforementioned door-chime apparatus 100 such that the latter will, under certain circumstances, audibilize messages (including word-based messages) on behalf of the non-door-chime apparatus 108 that are unrelated to door-chime functionality or utility as such. Further description along these lines will now be provided.

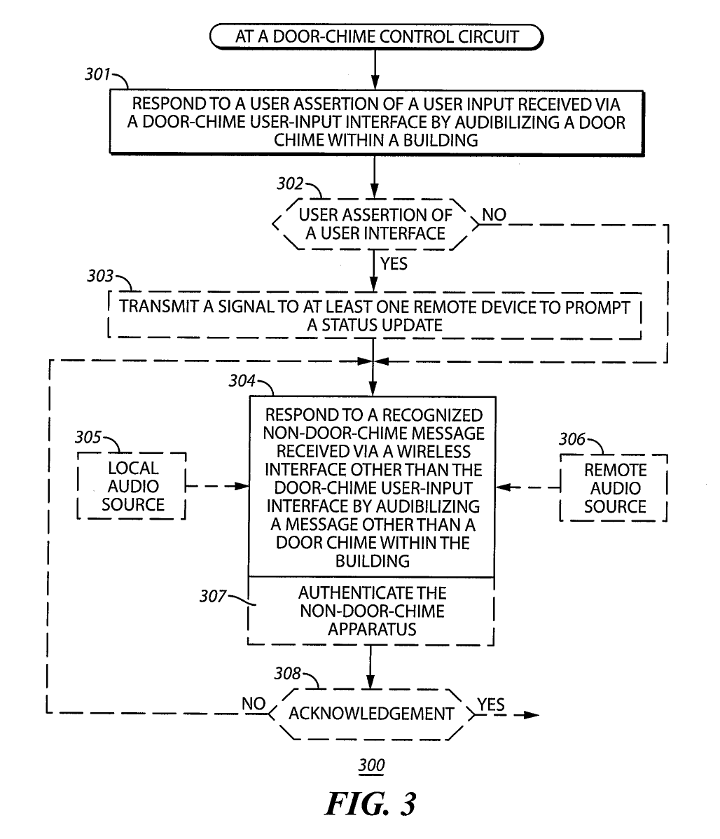

FIG. 3, for example, illustrates a process 300 that a door-chime control circuit can carry out. At step 301 of this process 300 the door-chime control circuit provides for responding to a user assertion of a user input (instigated, for example, by momentarily pushing a doorbell button) that the control circuit receives via the above-described door-chime user-input interface 103 by audibilizing a door chime within the building that harbors the door-chime control circuit. In effect, the door-chime control circuit acts like a door chime in these regards.

The remaining activities of this process 300 pertain to supporting the audibilization of non-door-chime content.

By one approach, this process 300 will provide the optional step 302 of detecting when a user (of the door-chime apparatus) asserts a user interface (such as the door-chime apparatus user interface 111 described above). This might comprise, for example, detecting when a homeowner asserts an actual or virtual button on the door-chime apparatus to seek status information regarding one or more non-door-chime apparatuses. When true, this process 300 can then respond with the optional step 303 of transmitting (using, for example, the aforementioned door-chime apparatus wireless interface 107) a signal to one or more remote devices (such as one or more non-door-chime apparatuses) to thereby prompt a status update.

In any event, at step 304 this process 300 provides for responding to a recognized non-door-chime message (received, for example, via the aforementioned wireless interface 107 and not via the aforementioned door-chime user-input interface 103) by audibilizing a message other than a door chime within the building.

Recognition of the non-door-chime message can comprise, for example, optionally authenticating 307 that an authorized non-door-chime apparatus 108 transmitted the non-door-chime message. These teachings will accommodate a wide variety of approaches in these regards. This might comprise, for example, determining that the non-door-chime message includes a unique portion that includes, for example, an appropriate previously-authorized fixed value (such as a particular integer) that identifies the non-door-chime apparatus.

This approach will permit the door-chime apparatus 100, for example, to recognize the received non-door-chime messages from any of a plurality of non-door-chime apparatuses. This, in turn, can be used by the door-chime apparatus 100 to determine not only the source for a particular received non-door-chime message but to also possibly understand other characterizing aspects of the sourcing non-door-chime apparatus (such as, but not limited to, a general categorization of what type of apparatus this is).

By another approach, in lieu of the foregoing or as used in conjunction therewith, this might comprise determining that the non-door-chime message has a unique portion that includes a rolling value that is properly associated with the non-door-chime apparatus. Such rolling values are known in the art. By one approach, for example, the transmitting apparatus will utilize a new rolling value for each new transmission that is to include a rolling value, where that change in the rolling value occurs pursuant to a plan known to both the transmitting apparatus and the receiving apparatus.

As is known in the art, the receiving apparatus can be configured to recognize a given rolling value as being acceptable even when the presently-presented rolling value is not the “next” rolling value that the receiving apparatus expects so long as the presently-presented rolling value is within a given allowance window. This might mean, for example, that a given presently-presented rolling value will be accepted so long as the presently-presented rolling value is within, say, three incremental changes of an expected rolling value.

Also as is known in the art, the non-door-chime message can convey such a fixed value and a rolling value in a format that is determined, at least in part, by at least a part of the rolling value. As one illustrative example in these regards, this might comprise, for example, using a particular data bit order pattern and/or a particular data inversion pattern that is selected as a function of the value of one or more bits of the rolling value itself. In such a case the door-chime apparatus can be configured to properly recover such information in order to properly decode the fixed value and/or the rolling value to facilitate these authentication purposes.

The interested reader can learn more about the use of fixed values and rolling values by referring to United States Published Patent Application No. 2007/0058811, entitled Method and Apparatus to Facilitate Transmission of an Encrypted Rolling Code, the contents of which are fully incorporated herein by this reference.

In some cases the received non-door-chime message may use a message identifier that simply identifies a particular message to be audibilized by the door-chime apparatus. This may be a specific identification (for example, an identification of a particular file name) or a general identification (for example, an indication that the door-chime apparatus is to use whatever message the latter may have that will provide a generic “all is well” indication). In such a case, this step 304 may draw upon a local audio source 305 and/or a remote audio source 306 as may be available to the door-chime apparatus 100.

Such a local audio source 305 can comprise, at least in part, one or more audio files that are stored in the door-chime apparatuses' memory 110. So configured, the door-chime apparatus 100 can call upon and access the particular audio file as corresponds to the received non-door-chime message and render that file audible in order to provide the audibilized message.

These teachings will accommodate a wide variety of audio files in these regards, including but not limited to MP3 format files (where “MP3” will be understood to refer to MPEG-1 or MPEG-2 audio layer III formatting as specified by the Moving Picture Experts Group), Advanced Audio Coding (AAC) format files, any of a variety of pulse-code modulation formatted files (including, for example, PWM, PDM, PAM, and so forth), Windows Media Audio (WMA) format files, WAVeform (WAV) audio format files, MPEG-4 format files, Audio Interchange File Format (AIFF) format files, Standard Musical Instrument Digital Interface (MIDI) File (SMF) format files, and so forth. As these and other file formats are well known in the art, and as these teachings are not especially sensitive to any particular selections in these regards, further description of these file formats is not provided here.

These teachings will also accommodate using files of textual content (such as, for example, ASCII content) that comprise the articulatable words. In this case, the door-chime apparatus can make use of a text-to-speech synthesizer (which are well known in the art) to articulate the text to thereby audibilize the words that comprise the message to be conveyed.

In the examples provided above the received non-door-chime message identifies, specifically or generally, a particular message to be audibilized by the door-chime apparatus. These teachings will also accommodate, however, having the non-door-chime apparatus itself provide some or all of the audio file content that the door-chime apparatus is to audibilize. In such a case, the aforementioned remote audio source 306 can itself comprise the non-door-chime apparatus. The non-door-chime apparatus can provide the audio file(s) as a part of the referred-to non-door-chime message or as part of an earlier-provided or subsequently-provided transmission. These teachings will also accommodate having the non-door-chime apparatus push this content to the door-chime apparatus or permitting the door-chime apparatus to pull this content from the non-door-chime apparatus as desired.

In any event, by one approach the audio file itself can comprise articulatable words (either alone or in conjunction with other non-verbal sounds, and either pre-recorded words or in a textual form as suggested above). In this case, the audibilized message can itself comprise articulated words. These articulated words, in turn, can convey any of a wide variety of facts and information via the door-chime apparatus 100.

These articulated words, for example, can convey information regarding maintenance of the non-door-chime apparatus that transmitted the corresponding recognized non-door-chime message. By one approach, this maintenance content can refer, for example, to scheduled maintenance events and deadlines. By another approach, alone or in conjunction with the foregoing, this maintenance content can refer to a detected fault condition or to a predicted fault condition.

As another example in these regards, these articulated words can convey information regarding an operational state of the corresponding non-door-chime apparatus. This might comprise, for example, an “end of cycle” indication or statement for apparatuses such as laundry dryers or washers, ovens, microwave ovens, automatic dishwashers, and so forth. For any of a wide variety of sensors this operating state information can relate to whether the sensor is, or is not, presently detecting one or more substances or conditions of interest (such as the presence or absence of smoke, a particular gas, a person or animal, light, moisture, detected motion in swimming pool water, a person standing at the front door, and so forth). This operational state can also relate, as desired, to such things as the state of a movable barrier (such as opened, closed, opening, closing, obstacle detected, and so forth). Generally speaking, these teachings will accommodate all manner of operational-state information as may relate to the specifics of any particular non-door-chime apparatus.

By one approach this step 304 can be carried out once in response to receiving a recognized non-door-chime message. If desired, however, this step 304 can comprise repeating the audibilization of the message until, for example, the door-chime apparatus's control circuit 102 receives an acknowledgement indication at optional step 308. By one approach, and by way of a non-limiting example, a homeowner might provide this acknowledgement by asserting the aforementioned user interface 111 or even the door-chime user inputs 104 (i.e., doorbell buttons). Such repetition could continue until such an acknowledgement is received or, if desired, until either an acknowledgement is received or a certain maximum number of repetitions or a maximum amount of time is achieved.

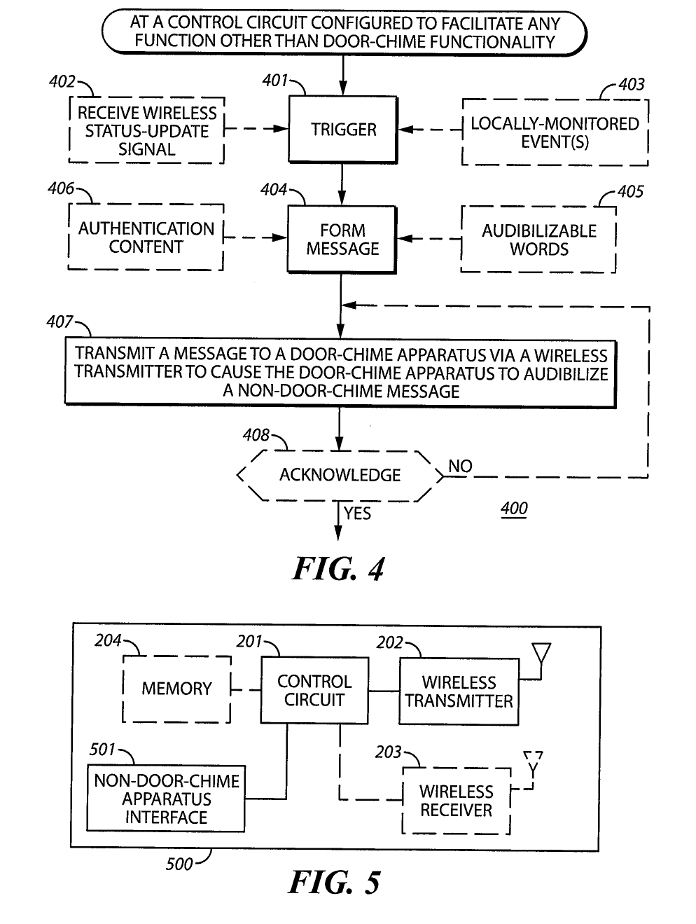

Referring now to FIG. 4, a corresponding illustrative process 400 that can be carried out by the aforementioned non-door-chime apparatuses 108 will be described. And again, this process 400 can be carried out by an appropriate control circuit such as the non-door-chime apparatus control circuit 201 described above.

At step 401 the control circuit detects a triggering event. By one approach, this triggering event can comprise the reception 402 of a wireless status-update signal from a corresponding door-chime apparatus as described above. By another approach, in lieu of the foregoing or in addition thereto, this triggering event can comprise one (or more) of one or more locally-monitored events 403. These locally-monitored events 403 can vary with the application setting. Examples include, but are not limited to, the aforementioned maintenance events, the aforementioned operational states, user assertion of a status-update user interface, and so forth.

At step 404, and in response to the aforementioned trigger 401, this process 400 provides for forming a message. This message can include, or represent, a status update for the non-door-chime apparatus and can, in particular, comprise the non-door-chime message described above. Accordingly, and also as described above, this formed message can include one or more audibilizable words 405 (such as pre-recorded words and/or text that can be articulated using a text-to-speech synthesizer). This formed message can also comprise, as desired, the aforementioned authentication content 406 (such as a fixed value that identifies the non-door-chime apparatus, a rolling value, and so forth).

At step 407 this process 400 then provides for transmitting the formed message to a corresponding door-chime apparatus via a wireless transmitter to thereby cause the door-chime apparatus to audibilize a corresponding non-door-chime message as described above. By one approach, the non-door-chime apparatus can repeatedly transmit this message (in a same or altered form as desired) until the non-door-chime apparatus receives an appropriate acknowledgement as per optional step 408. By one approach, and by way of example, this acknowledgement can be automatically or non-automatically sourced by the door-chime apparatus that receives the non-door-chime message.

These teachings will accommodate a wide variety of variations to accommodate differing application settings. By one approach, for example, a registration protocol can be utilized to initially couple a given non-door-chime apparatus with a given door-chime apparatus. Such a registration process may itself permit, for example, a given non-door-chime apparatus to transfer to the door-chime apparatus, prior to a time of need, one or more audio files that pertain (categorically or particularly) to the non-door-chime apparatus. Using this approach, the door-chime apparatus can make use of custom-fit verbal content at a time of need without requiring the use of bandwidth or time to provide that content to the door-chime apparatus. Such a registration protocol could also serve, if desired, to permit the door-chime apparatus to characterize the non-door-chime apparatus as belonging to a particular category of apparatuses to thereby permit the door-chime apparatus to select a particular category of message to audibilize when receiving status updates from this particular non-door-chime apparatus (presuming the absence of specific content in these regards).

As an example of another variation in these regards, the door-chime apparatus 100 can respond to the receipt of a message from a given non-door-chime apparatus 108 with a combination of an audibilized alert and a corresponding visual display (using, for example, one or more active displays as may comprise the aforementioned user interface 111). By way of illustration, the door-chime apparatus 100, upon receiving a text message from such a non-door-chime apparatus 108, can audibilize a sound notifying the homeowner to approach the door-chime apparatus 100 in order to view the displayed message. As an example the displayed message can be in a text format or can comprise, in whole or in part, an informational graphic icon. In such a case, the audibilized content itself can be specific and unique to the message and/or sourcing non-door-chime apparatus 108 or can, if desired, be more generic and non-specific.

As yet another example in these regards, as described above the non-door-chime apparatus 108 itself integrally comprises the control circuit 201 and wireless transmitter 202 that permits the transmission of the described non-door-chime message to the door-chime apparatus 100. If desired, however, the described transmission (and reception) capability can be segregated from the non-door-chime apparatus 108 itself. FIG. 5 provides an illustrative example of such a component 500. In this particular non-limiting illustrative example the component 500 can be essentially configured as described above but also includes a non-door-chime apparatus interface 501 that operably couples to the control circuit 201. This non-door-chime apparatus interface 501 permits the control circuit 201 to respond to one or more non-door-chime apparatuses 108 by transmitting a corresponding non-door-chime message as described above. The non-door-chime apparatus interface 501 itself can comprise a direct (wireless or non-wireless) connection to the non-door-chime apparatus 108 or can comprise an indirect connection. To facilitate an indirect connection, for example, the non-door-chime apparatus interface 501 can be configured to detect and respond to the direct and indirect signals that are provided by a given non-door-chime apparatus 108. This might comprise, for example, detecting an audible end-of-cycle signal provided by the non-door-chime apparatus 108, or detecting the presence or absence of mechanical vibrations that in turn offer indications regarding the present operating state of a given non-door-chime apparatus 108.

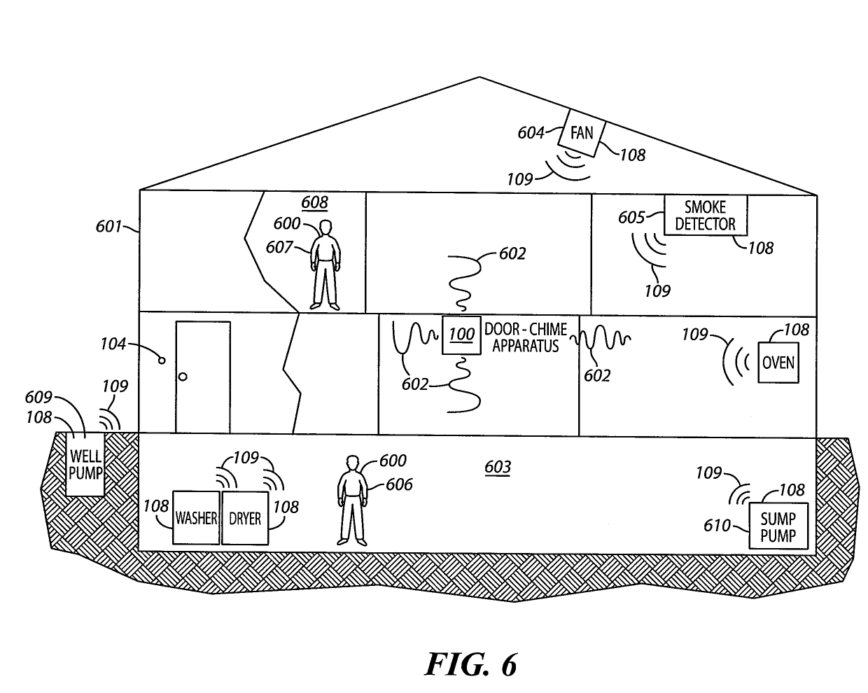

So configured, and referring now to FIG. 6, a wide variety of household utilities, appliances, sensors, and the like can be better assured that their status information of interest will likely be heard, and comprehended, by a homeowner 600 (shown in different locations using reference numerals 606 and 607) notwithstanding where in the residence 601 the non-door-chime apparatus 108 might be located. The homeowner 600, in turn, can enjoy an increased peace of mind that inures to such a practice. By employing these teachings the (typical) central location of a typical door-chime apparatus (and the typical installation practices that favor a good likelihood that the door-chime apparatus's audibilizations 602 will be heard substantially or fully throughout the residence 601) are leveraged in favor of any number of less-well-situated utilities, appliances, and sensors. For example, a person 606 in the basement 603 can more likely hear the audibilizations 602 provided by such a door-chime-apparatus 602 regarding a message concerning, say, an attic fan 604 or an upstairs smoke detector 605 while a person 607 in an upstairs bedroom 608 can now more likely hear audiblizations 602 as pertain to, say, an outside well pump 609 or a sump pump 610 located in the basement 603.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus comprising:
a door-chime chassis configured to install the apparatus in a building;
a door-chime user-input interface supported by the door-chime chassis;
a wireless interface supported by the door-chime chassis;
a control circuit supported by the door-chime chassis and responsive to both the door-chime user-input interface and the wireless interface, such that:
a user assertion of a user input received via the door-chime user-input interface will cause the control circuit to audibilize a door chime within the building;
reception of a recognized non-door-chime message via the wireless interface will cause the control circuit to audibilize a message other than a door chime within the building.

2. The apparatus of claim 1 wherein the door-chime user-input interface comprises at least one of:
a wireless interface;
a non-wireless interface.

3. The apparatus of claim 1 wherein the user input comprises a doorbell button.

4. The apparatus of claim 1 wherein the control circuit is configured to recognize non-door-chime messages from any of a plurality of non-door-chime apparatuses.

5. The apparatus of claim 4 wherein the plurality of non-door-chime apparatuses includes at least one of:
a residential utility;
a residential appliance;
a residential sensor.

6. The apparatus of claim 5 wherein the residential utility can comprise any of:
an installed pump;
a central furnace;
a central air conditioner;
a central humidity controller;
a heat pump system;
a movable barrier operator;
a water softener;
a garbage disposal;
an electricity generator.

7. The apparatus of claim 5 wherein the residential appliance can comprise any of:
an installed kitchen appliance;
a laundry appliance.

8. The apparatus of claim 5 wherein the residential appliance can comprise any of:
a washer;
a dryer;
a stove;
an oven;
a dish washer;
a refrigerator;
a freezer;
a microwave.

9. The apparatus of claim 5 wherein the residential sensor can comprise any of:
a smoke detector;
a gas detector;
a movement detector;
a living-presence detector;
a water detector;
an environmental-state detector;
an access detector;
a light sensor;
an alarm-condition system.

10. The apparatus of claim 9 wherein the access detector comprises at least one of:
a door-state detector;
a weight-based detector;
a window-state detector.

11. The apparatus of claim 9 wherein the movement detector comprises a passive-infrared-based detector.

12. The apparatus of claim 11 wherein the passive-infrared-based detector comprises a part of a light fixture.

13. The apparatus of claim 1 wherein the recognized non-door-chime message includes at least a portion of the message to be audibilized.

14. The apparatus of claim 13 wherein the recognized non-door-chime message includes, at least in part, an audio file to be rendered audible to thereby provide, at least in part, the message.

15. The apparatus of claim 14 wherein the audio file has a file format that is compatible with at least one of:
an MP3 format;
an Advanced Audio Coding (AAC) format;
a pulse-code modulation (PCM) format;
a Windows Media Audio (WMA) format;
a WAVeform audio file (WAV) format;
a Motion Picture Experts Group-4 (MPEG-4) format;
an Audio Interchange File Format (AIFF) format;
a Standard Musical Instrument Digital Interface (MIDI) File (SMF) format.

16. The apparatus of claim 1 wherein the control circuit is configured to audibilize the message other than a door chime using a local audio source.

17. The apparatus of claim 16 wherein the control circuit is configured to select the message from amongst a plurality of local candidate audio sources.

18. The apparatus of claim 17 wherein the control circuit is configured to select the message from amongst the plurality of local candidate audio sources using a message identifier as comprises at least a part of the recognized non-door-chime message.

19. The apparatus of claim 1 wherein the control circuit is configured to audibilize the message other than a door chime using an audio source that is remotely supplied at a time of need.

20. The apparatus of claim 19 wherein the audio source is remotely supplied by a non-door-chime apparatus other than a door-chime user-input interface.

21. The apparatus of claim 1 wherein the message comprises articulatable words.

22. The apparatus of claim 21 wherein the articulatable words convey information regarding maintenance of a non-door-chime apparatus that transmitted the recognized non-door-chime message.

23. The apparatus of claim 21 wherein the articulatable words convey information regarding an operational state of a non-door-chime apparatus that transmitted the recognized non-door-chime message.

24. The apparatus of claim 21 wherein the control circuit is configured to articulate the articulatable words by use of a text-to-speech synthesizer.

25. The apparatus of claim 21 wherein the control circuit is configured to select a particular language, from amongst a plurality of available candidate languages, to use when articulating the articulatable words.

26. The apparatus of claim 1 wherein the control circuit is configured to cause the control circuit to audibilize a message other than a door chime within the building in a repeated manner until the control circuit receives an acknowledgement indication.

27. The apparatus of claim 26 wherein the control circuit is configured to receive the acknowledgement indication via the door-chime user-input interface.

28. The apparatus of claim 1 further comprising:
a user interface;
wherein the control circuit is responsive to the user interface and wherein the control circuit is configured to select the message as a function, at least in part, of a setting entered by a user via the user interface.

29. The apparatus of claim 1 wherein the recognized non-door-chime message includes a unique portion that uniquely identifies a corresponding non-door-chime apparatus.

30. The apparatus of claim 29 wherein the unique portion includes a fixed value that identifies the non-door-chime apparatus.

31. The apparatus of claim 30 wherein the unique portion further comprises a rolling value associated with the non-door-chime apparatus, wherein the non-door-chime apparatus changes the rolling value for a new transmission that includes a rolling value.

32. The apparatus of claim 31 wherein the control circuit is configured to process the rolling value as recovered from the unique portion to assess whether the rolling value is within an allowance window in order to authenticate the non-door-chime apparatus.

33. The apparatus of claim 32 wherein the non-door-chime message conveys the fixed value and the rolling value in a format that is determined, at least in part, by at least a part of the rolling value.

34. The apparatus of claim 33 wherein the format comprises, at least in part, at least one of:
a data bit order pattern;
a data inversion pattern.

35. The apparatus of claim 1 further comprising:
a user interface supported by the door-chime chassis and operably coupled to the control circuit;
and wherein the control circuit is further configured to respond to a user assertion of the user interface by providing status information regarding at least one remote device that is configured to transmit the recognized non-door-chime message.

36. The apparatus of claim 35 wherein the control circuit is configured to provide the status information by audibilizing the status information.

37. The apparatus of claim 36 wherein the control circuit is configured to audibilize the status information by articulating words.

38. The apparatus of claim 35 wherein the control circuit is configured to provide the status information by, at least in part:
responding to user assertion of the user interface by transmitting a signal to the at least one remote device to prompt a status update;
receiving a status update message from the at least one remote device;
using the status update message to provide the status information.

39. The apparatus of claim 38 wherein using the status update message to provide the status update comprises, at least in part, audibilizing the status update message.

40. The apparatus of claim 39 wherein audibilizing the status update message comprises articulating words.

41. The apparatus of claim 40 wherein using the status update message to provide the status information further comprises, when the status update message does not comprise articulatable words, accessing previously-stored articulatable words and articulating the articulatable words.

42. A method comprising:
at a door-chime control circuit:
responding to a user assertion of a user input received via a door-chime user-input interface by audibilizing a door chime within a building;
responding to a recognized non-door-chime message received via a wireless interface other than the door-chime user-input interface by audibilizing a message other than a door chime within the building.

43. The method of claim 42 wherein the door-chime user-input interface comprises at least one of:
a wireless interface;
a non-wireless interface.

44. The method of claim 42 wherein the door-chime control circuit is configured to recognize non-door-chime messages from any of a plurality of non-door-chime apparatuses.

45. The method of claim 42 wherein the recognized non-door-chime message includes at least a portion of the message to be audibilized.

46. The method of claim 45 wherein the recognized non-door-chime message includes, at least in part, an audio file to be rendered audible to thereby provide, at least in part, the message.

47. The method of claim 46 wherein the audio file has a file format that is compatible with at least one of:
an MP3 format;
an Advanced Audio Coding (AAC) format;
a pulse-code modulation (PCM) format;
a Windows Media Audio (WMA) format;
a WAVeform audio file (WAV) format;
a Motion Picture Experts Group-4 (MPEG-4) format;
an Audio Interchange File Format (AIFF) format;
a Standard Musical Instrument Digital Interface (MIDI) File (SMF) format.

48. The method of claim 42 wherein the door-chime control circuit is configured to audibilize the message other than a door chime using a local audio source.

49. The method of claim 48 wherein the door-chime control circuit is configured to select the message from amongst a plurality of local candidate audio sources.

50. The method of claim 49 wherein the door-chime control circuit is configured to select the message from amongst the plurality of local candidate audio sources using a message identifier as comprises at least a part of the recognized non-door-chime message.

51. The method of claim 42 wherein the door-chime control circuit is configured to audibilize the message other than a door chime using an audio source that is remotely supplied at a time of need.

52. The method of claim 51 wherein the audio source is remotely supplied by a non-door-chime apparatus other than via a door-chime user-input interface.

53. The method of claim 42 wherein the message comprises articulatable words.

54. The method of claim 53 wherein the articulatable words convey information regarding maintenance of a non-door-chime apparatus that transmitted the recognized non-door-chime message.

55. The method of claim 53 wherein the articulatable words convey information regarding an operational state of a non-door-chime apparatus that transmitted the recognized non-door-chime message.

56. The method of claim 53 wherein the control circuit is configured to articulate the articulatable words by use of a text-to-speech synthesizer.

57. The method of claim 53 wherein the control circuit is configured to select a particular language, from amongst a plurality of available candidate languages, to use when articulating the articulatable words

58. The method of claim 42 wherein the control circuit is configured to cause the control circuit to audibilize a message other than a door chime within the building in a repeated manner until the control circuit receives an acknowledgement indication.

59. The method of claim 58 wherein the recognized non-door-chime message includes a unique portion that uniquely identifies a corresponding non-door-chime apparatus.

60. The method of claim 59 wherein the unique portion includes a fixed value that identifies the non-door-chime apparatus.

61. The method of claim 60 wherein the unique portion further comprises a rolling value associated with the non-door-chime apparatus, wherein the non-door-chime apparatus changes the rolling value for a new transmission by the non-door-chime apparatus that includes a rolling value.

62. The method of claim 61 wherein the door-chime control circuit is configured to process the rolling value as recovered from the unique portion to assess whether the rolling value is within an allowance window in order to authenticate the non-door-chime apparatus.

63. The method of claim 62 wherein the non-door-chime message conveys the fixed value and the rolling value in a format that is determined, at least in part, by at least a part of the rolling value.

64. The method of claim 63 wherein the format comprises, at least in part, at least one of:
a data bit order pattern;
a data inversion pattern.

65. An apparatus:
a wireless transmitter;
a control circuit configured to facilitate any function other than door-chime functionality, the control circuit being operably coupled to the wireless transmitter and being configured to transmit a message to a door-chime apparatus via the wireless transmitter to cause the door-chime apparatus to audibilize a non-door-chime message.

66. The apparatus of claim 65 wherein the non-door-chime message is specific to the apparatus.

67. The apparatus of claim 65 wherein the apparatus comprises one of:
a residential utility;
a residential appliance;
a residential sensor.

68. The apparatus of claim 67 wherein the residential utility can comprise any of:
an installed pump;
a central furnace;
a central air conditioner;
a central humidity controller;
a heat pump system;
a movable barrier operator;
a water softener;
a garbage disposal;
an electricity generator.

69. The apparatus of claim 67 wherein the residential appliance can comprise any of:
an installed kitchen appliance;
a laundry appliance.

70. The apparatus of claim 69 wherein the residential appliance can comprise any of:
a washer;
a dryer;
a stove;
an oven;
a dish washer;
a refrigerator;
a freezer;
a microwave.

71. The apparatus of claim 67 wherein the residential sensor can comprise any of:
a smoke detector;
a gas detector;
a movement detector;
a living-presence detector;
a water detector;
an environmental-state detector;
an access detector;
a light sensor;
an alarm-condition system.

72. The apparatus of claim 71 wherein the access detector comprises at least one of:
a door-state detector;
a weight-based detector;
a window-state detector.

73. The apparatus of claim 71 wherein the movement detector comprises a passive-infrared-based detector.

74. The apparatus of claim 73 wherein the passive-infrared-based detector comprises a part of a light fixture.

75. The apparatus of claim 67 wherein the message includes at least a portion of the non-door-chime message to be audibilized.

76. The apparatus of claim 75 wherein the message includes, at least in part, an audio file to be rendered audible to thereby provide, at least in part, the non-door-chime message.

77. The apparatus of claim 76 wherein the audio file has a file format that is compatible with at least one of:
an MP3 format;
an Advanced Audio Coding (AAC) format;
a pulse-code modulation (PCM) format;
a Windows Media Audio (WMA) format;
a WAVeform audio file (WAV) format;
a Motion Picture Experts Group-4 (MPEG-4) format;
an Audio Interchange File Format (AIFF) format;
a Standard Musical Instrument Digital Interface (MIDI) File (SMF) format.

78. The apparatus of claim 65 wherein the message includes a message identifier that identifies the non-door-chime message from amongst a plurality of candidate messages using a message identifier.

79. The apparatus of claim 65 wherein the non-door-chime message comprises at least one articulatable word.

80. The apparatus of claim 79 wherein the at least one articulatable word conveys information regarding maintenance of the apparatus.

81. The apparatus of claim 79 wherein the at least one articulatable word conveys information regarding an operational state of the apparatus.

82. The apparatus of claim 79 wherein the at least one articulatable word comprises text that the door-chime apparatus can render audible by use of a text-to-speech synthesizer.

83. The apparatus of claim 79 wherein the message identifies a particular language, from amongst a plurality of available candidate languages, to use when articulating words to audibilize the non-door-chime message.

84. The apparatus of claim 65 wherein the message includes a unique portion that uniquely identifies the apparatus.

85. The apparatus of claim 84 wherein the unique portion includes a fixed value that identifies the apparatus.

86. The apparatus of claim 85 wherein the unique portion further comprises a rolling value associated with the apparatus, wherein the control circuit changes the rolling value for a new transmission that includes a rolling value.

87. The apparatus of claim 86 wherein the message conveys the fixed value and the rolling value in a format that is determined, at least in part, by at least a part of the rolling value.

88. The apparatus of claim 87 wherein the format comprises, at least in part, at least one of:
a data bit order pattern;
a data inversion pattern.

89. The apparatus of claim 65 further comprising:
a wireless receiver operably coupled to the control circuit;
and wherein the control circuit is further configured to receive a signal from the door-chime apparatus via the wireless receiver and to respond by providing a status-update message regarding the apparatus to the door-chime apparatus via the wireless transmitter.

90. The apparatus of claim 89 wherein the status-update message includes, at least in part, word information that the door-chime apparatus can articulate to audibilize the status-update message.
